(19) United States
(12) Patent Application Publication
(10) Pub. No.: US 2010/0280159 A1
(43) Pub. Date: Nov. 4, 2010

(54) FLAME RETARDANT THERMOPLASTIC COMPOSITION AND ARTICLES FORMED THEREFROM

(76) Inventors: Christianus Johannes Jacobus Maas, Rilland (NL); Hendrik Cornelus Jacobus De Nooijer, Middelburg (NL); Andries Adriaan Volkers, Wouw (NL); Joshua Arie van den Bogerd, Tholen (NL)

Correspondence Address: CANTOR COLBURN, LLP, 20 Church Street, 22nd Floor, Hartford, CT, 06103, US

(21) Appl. No.: 12/237,408

(22) Filed: Sep. 25, 2008

(51) Int. Cl. C08K 5/42

(52) U.S. Cl. 524/162; 524/158; 524/161

(57) ABSTRACT

An embodiment of a thermoplastic resin composition can comprise a cyanophenyl endcapped polycarbonate resin; a potassium diphenyl sulphon-3-sulphonate; and brominated polycarbonate; wherein the composition. In some embodiments, when the composition is in the form of a 3 mm thick extruded sheet, the sheet has a smoke density of less than 200 at an exposure period of 240 seconds in accordance with the smoke density test as set forth in ASTM E662-06, and has no burning drips on the sheet for a duration of 10 minutes in accordance with the flammability test as set forth in NF-P-92-505.

### BACKGROUND OF THE INVENTION

The present disclosure generally relates to thermoplastic compositions, and more particularly, to flame retardant polycarbonate compositions.

Transparent polycarbonate sheet materials are commonly used in aircraft and other transportation interior applications. The transparent polycarbonate sheets can be used in interior applications, such as partition walls, ceiling panels, cabinet walls, storage compartments, galley surfaces, light panels, and the like. All of these applications have various flame safety requirements that the materials must meet in order to be used in the interior applications. Various requirements have been placed on the flame retardant and smoke generating properties of the materials used in the construction of these interior panels and parts. Particular requirements include smoke density and flame spread. In the United States, Federal Aviation Regulation (FAR) Part 25.853 lays out the airworthiness standards for aircraft compartment interiors. The safety standards for aircraft and transportation systems used in Europe include a smoke density test specified in FAR 25.5 Appendix F, Part V. Flammability requirements include the “60 seconds test” specified in FAR 25.853(a) and (a-1), or the French flame retardant tests such as, NF-P-92-504 (flame spread) or NF-P-92-505 (drip test). In another example, the aircraft manufacturer Airbus has smoke density and other safety requirements set forth in ABD0031.

Materials that can meet or exceed all the various safety requirements for aircraft interior components are desired by the aircraft industry. In view of the current interior compartment material safety standards, and in anticipation of future more stringent standards, materials that exceed governmental and aircraft manufacturer requirements are sought. Moreover, cost pressures in the industry have directed efforts toward the development of these thermoplastic polycarbonate materials with improved flammability and safety characteristics.

### BRIEF SUMMARY OF THE INVENTION

Disclosed herein are transparent flame retardant polycarbonate compositions and articles formed therefrom for use in aircraft and transportation interiors.

In one embodiment, a thermoplastic resin composition comprises: a cyanophenyl endcapped polycarbonate resin; an aromatic sulphone sulphonate; and brominated polycarbonate. When the composition is in the form of a 3 mm thick extruded sheet, the sheet has a smoke density of less than 200 at an exposure period of 240 seconds in accordance with the smoke density test as set forth in ASTM E662-06, and has no burning drips on the sheet for a duration of 10 minutes in accordance with the flammability test as set forth in NF-P-92-505.

In another embodiment, a thermoplastic composition comprises: 0.01 wt % to 0.6 wt % an aromatic sulphone sulphonate; a brominated polycarbonate, in an amount such that the composition comprises 0.26 wt % to 5.2 wt % bromine; and a cyanophenyl endcapped polycarbonate.

The above described and other features are exemplified by the following Figures and detailed description.

### DETAILED DESCRIPTION OF THE INVENTION

A flame retardant polycarbonate sheet can comprise halogen additives (e.g., a brominated polycarbonate) in order to pass the French flame spread test (NF-P-92-504), but the sheet emits smoke when burned. The material, therefore, can have issues passing some of the smoke generation standards.

Disclosed herein are transparent flame retardant polycarbonate sheet compositions that can be employed, for example, in aircraft or other transportation interiors. The polycarbonate compositions still comprise the halogenated flame retardant materials and meet the flammability and safety requirements for use in aircraft interiors. The flame retardant polycarbonate compositions described herein satisfy both the smoke density and flammability tests. Flammability rating and the smoke density standards are conflicting requirements. Not to be limited by theory, it is believed that halogenated flame retardants, such as bromine, are used in the polycarbonate compositions for their effectiveness in improving flame spread properties of the sheet and satisfying the stringent aircraft interior flammability standards. Brominated flame retardant additives, however, cause an increase in smoke when the sheet compositions are ignited. The flame retardant polycarbonate compositions described herein advantageously utilize a cyanophenyl endcapped polycarbonate with brominated polycarbonate in combination with an aromatic sulphone sulphonate (e.g., an alkali metal sulphone sulphonate such as a potassium diphenyl sulphon-3-sulphonate) to produce a transparent sheet that satisfies both the flammability and smoke density tests.

The flame retardant thermoplastic polycarbonate compositions utilize the cyanophenyl endcapped polycarbonate in combination with the aromatic sulphone sulphonate in quantities effective to pass the flammability and smoke generation limits set forth for aircraft interior applications. As used herein, a composition achieving the flammability rating means a composition which satisfies at least the FR-1 French Ministerial NF-P-92-505 test, also known as the French drip test. In pertinent part, the test described therein records the behavior of droplets produced by applying heat to a specimen of the sheet material to be tested. A successful test means that no droplets coming from the sheet ignite the cotton underneath. This test had a test duration of 10 minutes and used 4 specimens (70 millimeters (mm) by 70 mm with a minimum weight of 2 grams (g)) supported on a horizontal grid. The ignition source was a horizontal radiator (500 watts (W) radiation intensity) on the specimen that was 30 mm from the radiator (3 watts per square centimeter (W/cm²)). The receptacle for catching droplets was cotton wool located 300 mm below the grid. If the cotton wool ignited, the material failed. For simplicity sake, this test will be referred to as the “drip test” going forward.

Also as used herein, a composition satisfying the smoke generation requirements for aircraft compartment interiors means a composition which satisfies American Society for Testing and Materials (ASTM) standard E662 (2006). This test method uses a photometric scale to measure the density of smoke generated by the material. Polycarbonate sheets satisfying the smoke generation requirements for aircraft interiors have a smoke density of less than 200, in accordance with ASTM E662-06. Again, for simplicity sake, this test will now be referred to as the “smoke density test”. While these tests were chosen to show the ability of the flame retardant polycarbonate composition described herein to satisfy both the smoke generation and flammability requirements for aircraft interiors, the composition can advantageously comply with other related flammability and safety tests. Examples of other such tests can include, without limitation, other FR-One tests, such as NF-P-92-504, the tests described in 14 C.F.R. 25.853 Appendix F, aircraft manufacturer tests, such as the Airbus ABD0031 test, and the like.

In one embodiment, a thermoplastic resin composition comprises: a cyanophenyl endcapped polycarbonate resin; aromatic sulphone sulphonate; and brominated polycarbonate; wherein the composition, when in the form of a 3 mm extruded sheet, passes both a smoke density test as set forth in ASTM E662-06 and a flammability test as set forth in NF-P-92-505. The potassium diphenyl sulphon-3-sulphonate can be present in an amount of 0.01 weight percent (wt %) to 0.6 wt %, based on the total weight of the composition, specifically, in an amount of 0.1 wt % to 0.4 wt %, based on the total weight of the composition, more specifically, in an amount of 0.25 wt % to 0.35 wt %, based on the total weight of the composition. In addition, or alternatively, the brominated polycarbonate can comprise 24 wt % to 28 wt % bromine, based on the total weight of the brominated polycarbonate. The brominated polycarbonate can be present in an amount of 1 wt % to 20 wt %, based on the total weight of the composition, specifically, 2 wt % to 15 wt %, more specifically, 4 wt % to 12 wt %. The cyanophenyl endcapped polycarbonate can be a polycarbonate having repeating structural carbonate units of the formula:

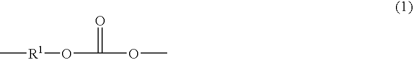

wherein at least 60 percent of the total number of R¹ groups contain aromatic organic groups and the balance thereof are aliphatic, alicyclic, or aromatic groups; and wherein the polycarbonate comprises cyanophenyl carbonate endcapping groups derived from reaction with a cyanophenol of the formula:

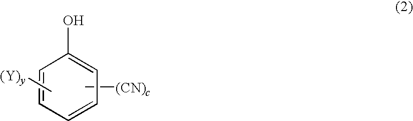

wherein Y is a halogen, C₁₋₃ alkyl group, C₁₋₃ alkoxy group, C₇₋₁₂ arylalkyl, alkylaryl, or nitro group, y is 0 to 4, and c is 1 to 5, provided that y+c is 1 to 5. The cyanophenyl endcapping groups can be present in an amount of 1 to 9 cyanophenyl carbonate units per 100 R¹ units, and/or the cyanophenol is p-cyanophenol, 3,4-dicyanophenol, or a combination comprising at least one of the foregoing phenols.

In another embodiment, the thermoplastic composition can comprise: 0.01 wt % to 0.6 wt % aromatic sulphone sulphonate, brominated polycarbonate, in an amount such that the composition comprises 0.26 wt % to 5.2 wt % bromine, and balance cyanophenyl endcapped polycarbonate.

In addition, it is to be understood that the elements of the embodiments may be combined in any suitable manner in the various embodiments that attain the desired properties (e.g., the drip test and the smoke density test).

Also disclosed are aircraft interior components comprising the above compositions. The aircraft interior component can comprise a partition wall, cabinet wall, sidewall panel, ceiling panel, floor panel, equipment panel, light panel, window molding, window slide, storage compartment, galley surface, equipment housing, seat housing, speaker housing, duct housing, storage housing, shelf, tray, or a combination comprising at least one of the foregoing.

Again, the flame retardant polycarbonate composition described herein comprises a cyanophenyl endcapped polycarbonate resin, a brominated polycarbonate, and aromatic sulphone sulphonate (e.g., KSS). The flame retardant additives of the composition herein can be present in any amount effective to satisfy both the drip test and the smoke density test. Exemplary concentrations of each component in the final flame retardant polycarbonate composition are discussed in detail below.

The polycarbonate composition comprising the cyanophenyl endcapped polycarbonate resin can be used to form a flame retardant sheet having improved flame retardant properties, e.g., compared to current flame retardant polycarbonate sheets comprising phenol or para-cumyl-phenol endcapped polycarbonate resins. Specifically, the polycarbonate composition provides a flame retardant sheet that passes the smoke density test, even when the composition includes greater than 10 percent by weight (wt %) of brominated polycarbonate, while greater than or equal to 8 wt % brominated polycarbonate in other compositions fails the smoke density test.

Polycarbonates endcapped with a cyanophenyl carbonate groups (for convenience herein, “cyanophenyl endcapped polycarbonates”) have repeating structural carbonate units of the formula (3):

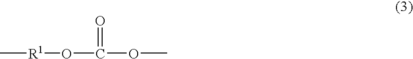

wherein at least 60 percent of the total number of R¹ groups contains aromatic organic groups and the balance thereof are aliphatic, alicyclic, or aromatic groups. In one embodiment, each R¹ group is a divalent aromatic group, for example derived from an aromatic dihydroxy compound of the formula (4):

HO-A¹-Y¹-A²-OH (4)

wherein each of A¹ and A² is a monocyclic divalent arylene group, and Y¹ is a single bond or a bridging group having one or two atoms that separate A¹ from A². In an exemplary embodiment, one atom separates A¹ from A². In another embodiment, when each of A¹ and A² is phenylene, Y¹ is para to each of the hydroxyl groups on the phenylenes. Illustrative non-limiting examples of groups of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging group Y¹ can be a hydrocarbon group or a saturated hydrocarbon group such as methylene, cyclohexylidene, or isopropylidene.

Included within the scope of formula (4) are bisphenol compounds of general formula (5):

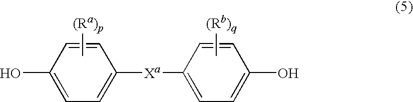

wherein R^{a} and R^{b} each represent a halogen atom or a monovalent hydrocarbon group and can be the same or different; p and q are each independently integers of 0 to 4; and X^{a} represents a single bond or one of the groups of formulas (6) or (7):

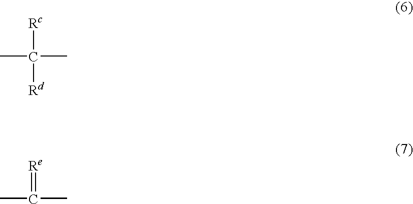

wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, and R^{e} is a divalent C₁₋₁₂ hydrocarbon group. In particular, R^{c} and R^{d} are each the same hydrogen or C₁₋₄ alkyl group, specifically the same C₁₋₃ alkyl group, even more specifically, methyl.

In an embodiment, R^{c} and R^{d} taken together represent a C₃₋₂₀ cyclic alkylene group or a heteroatom-containing C₃₋₂₀ cyclic alkylene group comprising carbon atoms and heteroatoms with a valency of two or greater. These groups can be in the form of a single saturated or unsaturated ring, or a fused polycyclic ring system wherein the fused rings are saturated, unsaturated, or aromatic. A specific heteroatom-containing cyclic alkylene group comprises at least one heteroatom with a valency of 2 or greater, and at least two carbon atoms. Exemplary heteroatoms in the heteroatom-containing cyclic alkylene group include —O—, —S—, and —N(Z)—, where Z is a substituent group selected from hydrogen, hydroxy, C₁₋₁₂ alkyl, C₁₋₁₂ alkoxy, or C₁₋₁₂ acyl.

In a specific exemplary embodiment, X^{a} is a substituted C₃₋₁₈ cycloalkylidene of the formula (8):

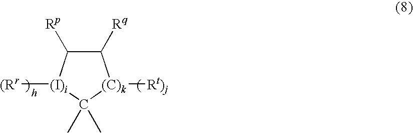

wherein each R^{r}, R^{p}, R^{q}, and R^{t} is independently hydrogen, halogen, oxygen, or C₁₋₁₂ organic group; I is a direct bond, a carbon, or a divalent oxygen, sulfur, or —N(Z)— wherein Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (8) will have an unsaturated carbon-carbon linkage where the ring is fused. When k is 1 and i is 0, the ring as shown in formula (8) contains 4 carbon atoms, when k is 2, the ring as shown contains 5 carbon atoms, and when k is 3, the ring contains 6 carbon atoms. In one embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group.

When k is 3 and i is 0, bisphenols containing substituted or unsubstituted cyclohexane units are used, for example bisphenols of formula (9):

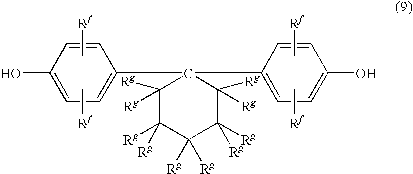

wherein each R^{f} is independently hydrogen, C₁₋₁₂ alkyl, or halogen; and each R^{g} is independently hydrogen or C₁₋₁₂ alkyl. The substituents can be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol containing polycarbonates, or a combination comprising at least one of the foregoing with other bisphenol polycarbonates, are supplied by Bayer Co. under the APEC® trade name.

Other useful dihydroxy compounds having the formula HO—R¹—OH include aromatic dihydroxy compounds of formula (10):

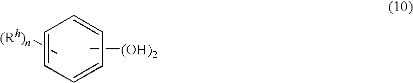

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

Some illustrative examples of dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9 to bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like, as well as combinations comprising at least one of the foregoing dihydroxy compounds.

Specific examples of bisphenol compounds that can be represented by formula (3) include 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations comprising at least one of the foregoing dihydroxy compounds can also be used.

“Polycarbonate” as used herein includes homopolycarbonates, copolymers comprising different R¹ moieties in the carbonate (referred to herein as “copolycarbonates”), and copolymers comprising carbonate units and other types of polymer units, such as ester units. In one specific embodiment, the polycarbonate is a linear homopolymer or copolymer comprising units derived from bisphenol A, in which each of A¹ and A² is p-phenylene and Y¹ is isopropylidene in formula (4). More specifically, at least 60%, particularly at least 80% of the R¹ groups in the polycarbonate are derived from bisphenol A.

Another specific type of copolymer is a polyester carbonate, also known as a polyester-polycarbonate. Such copolymers further contain, in addition to recurring carbonate chain units of the formula (3), repeating units of formula (11):

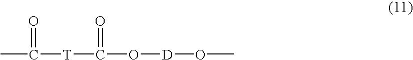

wherein D is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to 6 carbon atoms, specifically 2, 3, or 4 carbon atoms; and T divalent group derived from a dicarboxylic acid, and can be, for example, a C₂₋₁₀ alkylene group, a C₆₋₂₀ alicyclic group, a C₆₋₂₀ alkyl aromatic group, or a C₆₋₂₀ aromatic group.

In one embodiment, D is a C₂₋₃₀ alkylene group having a straight chain, branched chain, or cyclic (including polycyclic) structure. In another embodiment, D is derived from an aromatic dihydroxy compound of formula (5) above. In another embodiment, D is derived from an aromatic dihydroxy compound of formula (10) above.

Examples of aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations comprising at least one of the foregoing. A specific dicarboxylic acid comprises a combination of isophthalic acid and terephthalic acid wherein the weight ratio of isophthalic acid to terephthalic acid is 91:9 to 2:98. In another specific embodiment, D is a C₂₋₆ alkylene group and T is p-phenylene, m-phenylene, naphthalene, a divalent cycloaliphatic group, or a combination comprising at least one of the foregoing. This class of polyester includes the poly(alkylene terephthalates).

The molar ratio of ester units to carbonate units in the copolymers can vary broadly, for example 1:99 to 99:1, specifically 10:90 to 90:10, more specifically 25:75 to 75:25, depending on the desired properties of the final composition.

In a specific embodiment, the polyester unit of a polyester-polycarbonate can be derived from the reaction of a combination of isophthalic and terephthalic diacids (or derivatives thereof) with resorcinol. In another specific embodiment, the polyester unit of a polyester-polycarbonate is derived from the reaction of a combination of isophthalic acid and terephthalic acid with bisphenol-A. In a specific embodiment, the polycarbonate units are derived from bisphenol A. In another specific embodiment, the polycarbonate units are derived from resorcinol and bisphenol A in a molar ratio of resorcinol carbonate units to bisphenol A carbonate units of 1:99 to 99:1.

A specific example of a polycarbonate-polyester is a copolycarbonate-polyester-polysiloxane terpolymer comprising carbonate units of formula (3), ester units of formula (11), and polysiloxane (also referred to herein as “polydiorganosiloxane”) units of formula (12):

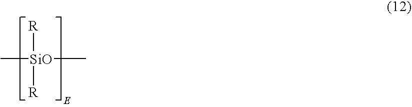

wherein each occurrence of R is same or different, and is a C₁₋₁₃ monovalent organic group. For example, R may independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups may be fully or partially halogenated with fluorine, chlorine, bromine, or iodine, or a combination comprising at least one of the foregoing. Combinations of the foregoing R groups may be used in the same copolymer. In an embodiment, the polysiloxane comprises R groups that have minimum hydrocarbon content. In a specific embodiment, an R group with minimum hydrocarbon content is a methyl group.

The value of E in formula (12) may vary widely depending on the type and relative amount of each component in the thermoplastic composition, the desired properties of the composition, and like considerations. Herein, E has an average value of 4 to 50. In an embodiment, E has an average value of 16 to 50, specifically 20 to 45, and more specifically 25 to 45. In another embodiment, E has an average value of 4 to 15, specifically 5 to 15, more specifically 6 to 15, and still more specifically 7 to 12.

In an embodiment, polydiorganosiloxane units are derived from dihydroxy aromatic compound of formula (13):

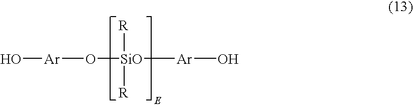

wherein E is as defined above; each R may independently be the same or different, and is as defined above; and each Ar may independently be the same or different, and is a substituted or unsubstituted C₆₋₃₀ arylene group, wherein the bonds are directly connected to an aromatic moiety. Suitable Ar groups in formula (13) may be derived from a C₆₋₃₀ dihydroxy aromatic compound, for example a dihydroxy aromatic compound of formula (4), (5), (9), or (10) above. Combinations comprising at least one of the foregoing dihydroxy aromatic compounds may also be used. Exemplary dihydroxy aromatic compounds are resorcinol (i.e., 1,3-dihydroxybenzene), 4-methyl-1,3-dihydroxybenzene, 5-methyl-1,3-dihydroxybenzene, 4,6-dimethyl-1,3-dihydroxybenzene, 1,4-dihydroxybenzene, 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulfide), and 1,1-bis(4-hydroxy-t-butylphenyl)propane. Combinations comprising at least one of the foregoing dihydroxy compounds may also be used. In an embodiment, the dihydroxy aromatic compound is unsubstituted, or is not substituted with non-aromatic hydrocarbon-containing substituents such as, for example, alkyl, alkoxy, or alkylene substituents.

In a specific embodiment, where Ar is derived from resorcinol, the polydiorganosiloxane repeating units are derived from dihydroxy aromatic compounds of formula (14):

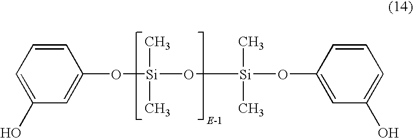

or, where Ar is derived from bisphenol-A, from dihydroxy aromatic compounds of formula (15):

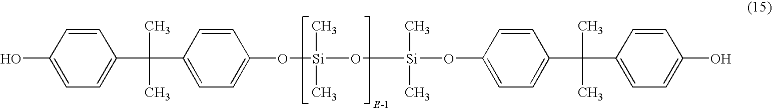

wherein E is as defined above.

In another embodiment, polydiorganosiloxane units are derived from dihydroxy aromatic compound of formula (16):

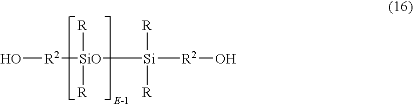

wherein R and E are as described above, and each occurrence of R² is independently a divalent C₁₋₃₀ alkylene or C₇₋₃₀ arylene-alkylene, and wherein the polymerized polysiloxane unit is the reaction residue of its corresponding dihydroxy aromatic compound. In a specific embodiment, where R² is C₇₋₃₀ arylene-alkylene, the polydiorganosiloxane units are derived from dihydroxy aromatic compound of formula (17):

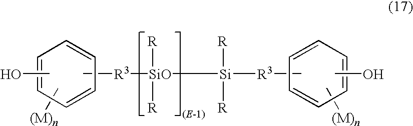

wherein R and E are as defined above. Each R³ is independently a divalent C₂₋₈ aliphatic group. Each M may be the same or different, and may be a halogen, cyano, nitro, C₁₋₈ alkylthio, C₁₋₈ alkyl, C₁₋₈ alkoxy, C₂₋₈ alkenyl, C₂₋₈ alkenyloxy group, C₃₋₈ cycloalkyl, C₃₋₈ cycloalkoxy, C₆₋₁₀ aryl, C₆₋₁₀ aryloxy, C₇₋₁₂ arylalkyl, C₇₋₁₂ arylalkoxy, C₇₋₁₂ alkylaryl, or C₇₋₁₂ alkylaryloxy, wherein each n is independently 0, 1, 2, 3, or 4.

In an embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R³ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is 0 or 1, R³ is a divalent C₁₋₃ aliphatic group, and R is methyl.

In a specific embodiment, the polydiorganosiloxane units are derived from a dihydroxy aromatic compound of formula (18):

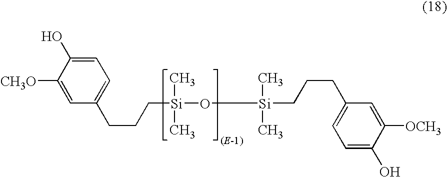

wherein E is as described above.

In another specific embodiment, the polydiorganosiloxane units are derived from dihydroxy aromatic compound of formula (19):

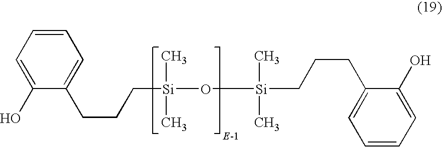

wherein E is as defined above.

Dihydroxy polysiloxanes typically can be made by functionalizing a substituted siloxane oligomer of formula (20):

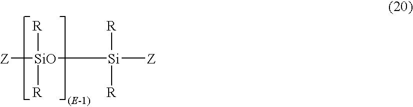

wherein R and E are as previously defined, and Z is H, halogen (Cl, Br, I), or carboxylate. Exemplary carboxylates include acetate, formate, benzoate, and the like. In an exemplary embodiment, where Z is H, compounds of formula (20) may be prepared by platinum catalyzed addition with an aliphatically unsaturated monohydric phenol. Suitable aliphatically unsaturated monohydric phenols included, for example, eugenol, 2-allylphenol, 4-allylphenol, 4-allyl-2-methylphenol, 4-allyl-2-phenylphenol, 4-allyl-2-bromophenol, 4-allyl-2-t-butoxyphenol, 4-phenyl-2-allylphenol, 2-methyl-4-propenylphenol, 2-allyl-4,6-dimethylphenol, 2-allyl-4-bromo-6-methylphenol, 2-allyl-6-methoxy-4-methylphenol, and 2-allyl-4,6-dimethylphenol. Combinations comprising at least one of the foregoing may also be used. Where Z is halogen or carboxylate, functionalization may be accomplished by reaction with a dihydroxy aromatic compound of formulas (4), (5), (9), (10), or a combination comprising at least one of the foregoing dihydroxy aromatic compounds. In an exemplary embodiment, compounds of formula (13) may be formed from an alpha, omega-bisacetoxypolydiorangonosiloxane and a dihydroxy aromatic compound under phase transfer conditions.

Specific copolycarbonate terpolymers include those with polycarbonate units of formula (3) wherein R¹ is a C₆₋₃₀ arylene group, polysiloxane units derived from siloxane diols of formula (15), (18) or (19), and polyester units wherein T is a C₆₋₃₀ arylene group. In an embodiment, T is derived from isophthalic and/or terephthalic acid, or reactive chemical equivalents thereof. In another embodiment, R¹ is derived from the carbonate reaction product of a resorcinol of formula (10), or a combination of a resorcinol of formula (10) and a bisphenol of formula (5).

The relative amount of each type of unit in the foregoing terpolymer will depend on the desired properties of the terpolymer, and are readily determined by one of ordinary skill in the art without undue experimentation, using the guidelines provided herein. For example, the polycarbonate-polyester-polysiloxane terpolymer can comprise siloxane units in an amount of 0.1 to 25 weight percent (wt. %), specifically 0.2 to 10 wt. %, more specifically 0.2 to 6 wt. %, even more specifically 0.2 to 5 wt. %, and still more specifically 0.25 to 2 wt. %, based on the total weight of the polycarbonate-polyester-polysiloxane terpolymer, with the proviso that the siloxane units are provided by polysiloxane units covalently bonded in the polymer backbone of the polycarbonate-polyester-polysiloxane terpolymer. The polycarbonate-polyester-polysiloxane terpolymer can further comprise 0.1 to 49.85 wt. % carbonate units, 50 to 99.7 wt. % ester units, and 0.2 to 6 wt. % polysiloxane units, based on the total weight of the polysiloxane units, ester units, and carbonate units. Alternatively, the polycarbonate-polyester-polysiloxane terpolymer comprises 0.25 to 2 wt. % polysiloxane units, 60 to 96.75 wt. % ester units, and 3.25 to 39.75 wt. % carbonate units, based on the total weight of the polysiloxane units, ester units, and carbonate units.

Polycarbonates can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as, for example, triethylamine or a phase transfer catalyst, under controlled pH conditions, e.g., 8 to 11. The most commonly used water immiscible solvents include methylene chloride, 1,2-dichloroethane, chlorobenzene, toluene, and the like.

Exemplary carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary embodiment, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be 0.1 to 10 wt. % based on the weight of bisphenol in the phosgenation mixture. In another embodiment an effective amount of phase transfer catalyst can be 0.5 to 2 wt. % based on the weight of bisphenol in the phosgenation mixture.

Alternatively, melt processes can be used to make the cyanophenol endcapped polycarbonates. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl)carbonate, bis(2-acetylphenyl)carboxylate, bis(4-acetylphenyl)carboxylate, or a combination comprising at least one of the foregoing. In addition, useful transesterification catalyst for use can include phase transfer catalysts of formula (R³)₄Q⁺X above, wherein each R³, Q, and X are as defined above. Exemplary transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of 0.05 to 2.0 wt. %. Mixtures comprising linear polycarbonates and branched polycarbonates can be used.

The cyanophenols can be added to the polymerization reaction as an endcapping agent using conventionally known processes. In one embodiment it is advantageous to decrease, minimize, or prevent contact between the cyanophenol and components that result in cyanophenol byproducts, in particular the corresponding carboxylic acids and/or amides. For example, it is common to add endcapping agents as part of a warm aqueous solution of a caustic (i.e., alkali and alkaline earth metal hydroxides such as sodium hydroxide dissolved in water). If such contact occurs, side products can form, such as the corresponding hydroxybenzamide and/or hydroxybenzoic acid. Such side products tend to be insoluble or otherwise incompatible with the interfacial reaction, and can also cause error in obtaining the target molecular weight of the polycarbonate.

It has accordingly been found useful to modify the reaction conditions employed to produce the endcapped polycarbonates so as to use cyanophenols that are essentially free of acid and amide groups. As used herein, “essentially free of” acid and amide groups means that the total number of acid and amide end groups are less than that detectable by Fourier transform infrared (FT-IR) analysis of the p-cyanophenol prior to addition to the polycarbonate reaction. Addition of the cyanophenol as a component in a warm aqueous solution of caustic is therefore to be avoided.

Other endcapping agents can also be used with phenol containing a cyano substituent, provided that such agents do not significantly adversely affect the desired properties of the compositions, such as transparency, ductility, flame retardance, and the like. In one embodiment only a cyanophenol, specifically p-cyanophenol, is used as an endcapping agent. Exemplary additional chain stoppers include certain other mono-phenolic compounds, mono-carboxylic acid chlorides, and/or mono-chloroformates. Mono-phenolic chain stoppers are exemplified by monocyclic phenols such as phenol and C₁-C₂₂ alkyl-substituted phenols such as p-cumyl-phenol, resorcinol monobenzoate, and p-and tertiary-butyl phenol; and monoethers of diphenols, such as p-methoxyphenol. Alkyl-substituted phenols with branched chain alkyl substituents having 8 to 9 carbon atoms can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used with cyanophenols as chain stopping agents. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations comprising at least one of the foregoing; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations comprising at least one of the foregoing.

The relative amount of cyanophenol used in the manufacture of the polymer will depend on a number of considerations, for example the type of R¹ groups, the use of a branching agent, and the desired molecular weight of the polycarbonate. In general, the amount of cyanophenol is effective to provide 1 to 9 cyanophenyl carbonate units per 100 R¹ units, specifically 2 to 8 cyanophenyl carbonate units per 100 R¹ units, and more specifically 2.5 to 7 cyanophenyl carbonate units per 100 R¹ units. Up to half of the cyanophenyl carbonate units can be replaced by a different type of endcapping unit as described above.

The cyanophenyl endcapped polycarbonates can have a weight average molecular weight (Mw) of 5,000 to 200,000, specifically 10,000 to 100,000 grams per mole (g/mol), even more specifically 15,000 to 60,000 g/mol, still more specifically 16,000 to 45,000 g/mol, as measured by gel permeation chromatography (GPC), using a crosslinked styrene-divinylbenzene column and calibrated to polycarbonate references. GPC samples are prepared at a concentration of 1 mg/ml, and are eluted at a flow rate of 1.5 ml/min.

Melt volume flow rate (often abbreviated “MVR”) measures the rate of extrusion of a thermoplastic through an orifice at a prescribed temperature and load. The cyanophenyl endcapped polycarbonates can have an MVR, measured at 300° C. under a load of 1.2 kg, of 0.1 to 200 cubic centimeters per 10 minutes (cm³/10 min), specifically 1 to 100 cm³/10 min.

The aromatic sulfone sulfonate can comprise a formula (K-1) compound:

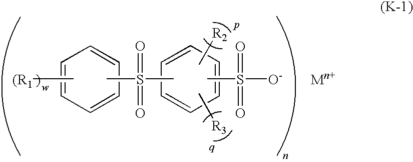

wherein R₁, R₂, and R₃ are independently selected from a C₁-C₆ alkyl group such as methyl and ethyl; M is a metal (e.g., an alkali metal such as sodium, potassium, and so forth); n is an integer and 1≦n≦3; w is an integer and 0≦w≦5; p and q are integers, p≧0, q≧0, and p+q≦4.

For example, in formula (K-1), M may be potassium, n=1, and w=p=q=0. The component (ii) of the thermoplastic composition is therefore potassium diphenylsulphone sulphonate (KSS), e.g. a formula (K-2) compound:

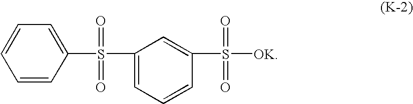

For example, the aromatic sulfone sulphonate, which can be represented by the following formula (K-3) compound:

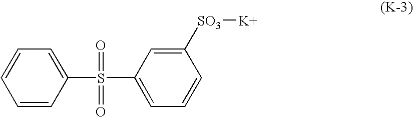

In some embodiments, the aromatic sulphone sulphonate (e.g., KSS) can be present in the final composition in quantities effective to achieve the requirements for use in aircraft compartment interiors. Suitable amounts of the aromatic sulphone sulphonate will vary, and can depend on, for example, the desired flame retardance, the amount of cyanophenyl encapped polycarbonate resin present, and the amount of the brominated polycarbonate included in the composition. Exemplary amounts of aromatic sulphone sulphonate present in the final flame retardant polycarbonate composition can be 0.01 percent by weight (wt %) to 0.6 wt %, specifically 0.1 wt % to 0.4 wt %, and more specifically 0.25 wt % to 0.35 wt % (e.g., 0.3 wt %), based on the total weight of the polycarbonate composition.

The flame retardant polycarbonate composition herein further comprises brominated polycarbonate to aid in achieving the desired flammability properties for a transparent sheet made of the composition for use in aircraft interiors. The brominated polycarbonate can be present in the composition in an amount effective to satisfy the flammability test, without negatively impacting the smoke density test. Brominated polycarbonate concentrations can depend on, for example, the desired flame retardance and smoke generation properties of the final composition, the amount of cyanophenyl endcapped polycarbonate resin present, and the amount of the aromatic sulphone sulphonate included in the composition.

In an exemplary embodiment, the brominated polycarbonate has a bromine content of 24 wt % to 28 wt % (e.g., 26 wt %). Exemplary amounts of brominated polycarbonate, containing 26 wt % bromine, in the final flame retardant composition can be 1 wt % to 20 wt %, specifically 2 wt % to 15 wt %, and more specifically 4 wt % to 12 wt %, based on the total weight of the composition. In other words, the composition can comprise 0.26 wt % to 5.2 wt %, specifically 0.52 wt % to 3.9 wt %, and more specifically 1.04 wt % to 3.12 wt % bromine, based on the total weight of the composition.

The brominated polycarbonates present in the final composition can be a high molecular weight, flame retardant, thermoplastic, aromatic polymer having a weight average molecular weight (Mw) of 8,000 to more than 200,000 atomic mass units (AMU), specifically of 20,000 to 80,000 AMU, and an intrinsic viscosity of 0.40 to 1.0 dl/g as measured in methylene chloride at 25° C. The brominated polycarbonate can be branched or unbranched.

In an exemplary embodiment, the brominated polycarbonate is derived from brominated dihydric phenols and carbonate precursors. Alternatively, the brominated polycarbonate can be derived from a carbonate precursor and a mixture of brominated and non-brominated aromatic dihydric phenols. Flame retardant brominated polycarbonates are disclosed, for example, in U.S. Pat. No. 4,923,933, U.S. Pat. No. 4,170,711, and U.S. Pat. No. 3,929,908.

Exemplary brominated dihydric phenols include 2,2-bis(3,5-dibromo-4-hydroxyphenyl)propane and 2,2′,6,6′-tetramethyl-3,3′,5,5′-tetrabromo-4,4′-biphenol. Exemplary non-brominated dihydric phenols for mixing with brominated dihydric phenols to produce brominated polycarbonates include, for example, 2,2-bis(4-hydroxyphenyl)propane, bis(4-hydroxyphenyl)methane, 2,2-bis(4-hydroxy-3-methylphenyl)propane, 4,4-bis(4-hydroxyphenyl)heptane, and (3,3′-dichloro-4,4′-dihydroxydiphenyl)methane. Mixtures of two or more different brominated and non-brominated dihydric phenols can be used. Branched brominated polycarbonates can also be used, as can blends of a linear brominated polycarbonate and a branched brominated polycarbonate.

The carbonate precursor can be a carbonyl halide. The carbonyl halides which can be used are carbonyl bromide, carbonyl chloride, and mixtures thereof.

The brominated polycarbonates used in the flame retardant thermoplastic composition can be manufactured according to procedures known in the art, such as, for example, by reacting a brominated dihydric phenol, or a mixture of brominated dihydric phenol and a non-brominated dihydric phenol, with a carbonate precursor such as diphenyl carbonate or phosgene in accordance with the methods set forth, for example, in U.S. Pat. Nos. 4,081,750 and 4,123,436. If a mixture of dihydric phenols is used, then exemplary mixtures contain greater than or equal to 25 percent of a brominated dihydric phenol; specifically 25 to 55 mole percent of a brominated dihydric phenol so as to render a flame retardant brominated polycarbonate. In an exemplary embodiment, the polycarbonate is derived from a dihydric phenol composition containing 25 to 35 mole percent of a brominated dihydric phenol and 75 to 65 mole percent of a non-brominated dihydric phenol.

Aromatic brominated polycarbonates can be prepared by using a monofunctional molecular weight regulator, an acid acceptor and a catalyst, along with the brominated polycarbonate bisphenol. The molecular weight regulators which can be used include phenol, alkylated phenols, such as 4-(1,1,3,3-tetramethylbutyl)phenol, paratertiary-butyl-phenol, 4-cumyl phenol, and the like. In an exemplary embodiment, phenol or an alkylated phenol is used as the molecular weight regulator.

The acid acceptor can be either an organic or an inorganic acid acceptor. An exemplary organic acid acceptor is a tertiary amine and can include such materials as pyridine, triethylamine, dimethylaniline, tributylamine, and the like. The inorganic acid acceptor can be one which can be a hydroxide, a carbonate, a bicarbonate, or a phosphate of an alkali or alkaline earth metal.

The catalysts which can be used are those that can aid the polymerization of the monomer with phosgene. Exemplary catalysts include tertiary amines such as triethylamine, tripropylamine, N,N-dimethylaniline, quaternary ammonium compounds such as, for example, tetraethylammonium bromide, cetyl triethyl ammonium bromide, tetra-n-heptylammonium iodide, tetra-n-propyl ammonium bromide, tetramethylammonium chloride, tetra-methyl ammonium hydroxide, tetra-n-butyl ammonium iodide, benzyltrimethyl ammonium chloride, and quaternary phosphonium compounds such as, for example, n-butyltriphenyl phosphonium bromide, and methyltriphenyl phosphonium bromide.

The cyanophenyl endcapped polycarbonate resin, the brominated polycarbonate, and the KSS flame retardant are added to a polycarbonate resin to form the flame retardant thermoplastic polycarbonate composition. As used herein, the term “polycarbonate” means compositions having repeating structural carbonate units of formula (1) as described above.

As mentioned throughout, the flame retardant polycarbonate composition can be employed in a variety of aircraft compartment interior applications, as well as interior applications for other modes of transportation, such as bus, train, subway, and the like. Exemplary aircraft interior components can include, without limitation, partition walls, cabinet walls, sidewall panels, ceiling panels, floor panels, equipment panels, light panels, window moldings, window slides, storage compartments, galley surfaces, equipment housings, seat housings, speaker housings, duct housing, storage housings, shelves, trays, and the like. The flame retardant polycarbonate compositions can be formed into sheets that can be used for any of the above mentioned components. It is generally noted that the overall size, shape, thickness, optical properties, and the like of the flame retardant polycarbonate sheet can vary depending upon the desired application.

In some interior compartment applications, it can be desirable for the flame retardant polycarbonate sheet to have certain optical properties. For example, it can be desirable to have a transparent flame retardant sheet. With regards to the transparency of the flame retardant polycarbonate sheet, it is briefly noted that end user specifications (e.g., commercial airline specifications) generally specify that the component satisfy a particular predetermined threshold. Haze values, as measured by ANSI/ASTM D1003-00, Procedure A, illuminant C, can be a useful determination of the optical properties of the transparent flame retardant polycarbonate sheet. The lower the haze levels, the better the transparency of the finished sheet. Exemplary haze levels for the transparent flame retardant polycarbonate sheet described herein, when measured at a thickness of 5.0 millimeters (mm), can be 0% to 6%, specifically 0.5% to 4%, and more specifically 1% to 2.5%. It is further noted that the transparency can be greater than or equal to 60%, specifically, greater than or equal to 75%, more specifically, greater than or equal to 90%, as measured in accordance with ASTM D1003-00, Procedure A, illuminant C.

Methods for forming the flame retardant polycarbonate composition can vary. In one embodiment, the polycarbonate polymer resin is blended with the brominated polycarbonate resin, the cyanophenyl endcapped polycarbonate resin, and the aromatic sulphone sulphonate (e.g., KSS), such as for example, in a screw-type extruder. The additives and resin can be combined in any form, for example, powder, granular, filamentous, and the like. The composition blend can then be extruded and pelletized. The pellets can be suitable for molding into thermoplastic interior parts, or they can be used in forming a sheet of the flame retardant polycarbonate composition. In some embodiments, the composition can be extruded (or co-extruded with a coating or other layer) in the form of a sheet and/or can be processed through calendaring rolls to form the desired sheet.

The disclosure is further illustrated by the following Examples. It should be understood that the non-limiting examples are merely given for the purpose of illustration. Unless otherwise indicated, all parts and percentages are by weight based upon the total weight of the flame retardant polycarbonate composition.

### Examples

In the examples below, the following terms have the meanings set forth below in Table 1.

TABLE 1

| Material | | |
|---|---|---|
| name | Chemical name | Supplier |
| PC-Br | Co-polymer of TBBPA (tetrabromo bisphenol | SABIC |
| | acetone) and BPA containing 26 wt % bromine | Innovative |
| | with a melt flow of 5-8 g/10 min (ASTM | Plastics |
| | D1238, 300° C., 2.16 kg) | |
| KSS | Potassium diphenyl sulfon-3-sulphonate | Arichem |
| | | LLC |
| PC-CN | Cyanophenyl endcapped polycarbonate resin | SABIC |
| | with a Mw of 30,000 g/mol | Innovative |
| | | Plastics |
| Linear PC | Linear polycarbonate resin with a wt. Avg. | Sabic |
| | MW of 30,000 (having an Intrinsic viscosity | Innovative |
| | of 58.5) | Plastics |
| Rimar salt | Potassium perfluorobutane sulfonate | 3M |
| Irgaphos ™ | Tris(di-t-butylphenyl)phosphite (heat stabilizer) | Great |
| 168 | | Lakes |

Drip and smoke density tests were conducted for various combinations of the materials listed in Table 1. The results are set forth below for each of the sample formulations. The various formulations were prepared by compounding on a Werner and Pfleider ZSK 25 mm intermeshing twin screw extruder at 300 revolutions per minute (rpm) and at a throughput of 20 kilograms per hour (kg/hr) with a torque of 75%. The barrel temperature settings from feed throat toward the direction of the twin strand die were set at 40-150-250-285-300-300-300-300° C. respectively for each heating zone. The die temperature was set at 300° C. The polymer strand was cooled by a water bath prior to pelletization. The tests were conducted on 2 and 3 millimeter (mm) thick sheets of the flame retardant polycarbonate composition formed from the pellets. The sheets had dimensions of 75 mm×305 mm. The drip tests were conducted in accordance with FR-1 French Ministerial NF-P-92-505. It is noted that the samples were tested when cut in extrusion direction and in the cross extrusion direction, but no differences were seen. A successful drip test had no burning drips coming off the sheet sample for 10 minutes.

For each composition, four different sheet samples were tested and the percentage of those that passed was reported in the tables below. The smoke density tests were conducted in accordance with ASTM E662-06/IMO MC.41(64). For this test, measurement was made of the attenuation of a light beam by smoke (suspended solid or liquid particles) accumulating within a closed chamber due to non-flaming pyrolytic decomposition and flaming combustion. For the test, a 3 inch by 3 inch sample was mounted within an insulated ceramic tube with an electrically heated radiant-energy source mounted therein. To satisfy aircraft requirements, a successful smoke density test is below 200 at an exposure period of 240 seconds as measured by a photometric system. For each formulation, three different sheet samples were tested for smoke density, and the average smoke density was calculated. Those tests were reported in the tables below as well.

Various flame retardant polycarbonate formulations were measured for flammability and smoke generation properties. Table 2 illustrates the test results of comparative formulations comprising linear polycarbonate resin currently used in flame retardant polycarbonate sheets for aircraft interiors. Table 3 illustrates test results for sample formulations including the cyanophenyl encapped polycarbonate resin described herein.

TABLE 2

| | | | | | | | | Drip Test |
|---|---|---|---|---|---|---|---|---|
| | Irgaphos ™ | | | | | Smoke | Smoke | (% of |
| | 168 | PC-Br | KSS | Rimar Salt | Linear PC | Density | Density | passing |
| Sample | (wt %) | (wt %) | (wt %) | (wt %) | (wt %) | (avg) | (Pass/Fail) | samples) |
| 1 | 0.05 | — | 0.1 | — | 99.85 | 186 | PASS | 0 |
| 2 | 0.05 | 3.0 | 0.1 | — | 96.85 | 145 | PASS | 25 |
| 3 | 0.05 | 6.0 | 0.1 | — | 93.85 | 117 | PASS | 0 |
| 4 | 0.05 | 6.0 | 0.3 | — | 93.65 | 134 | PASS | 80 |
| 5 | 0.05 | 8.0 | 0.1 | — | 91.85 | 259 | FAIL | 25 |
| 6 | 0.05 | 12.0 | 0.1 | — | 87.85 | 244 | FAIL | 60 |
| 7 | 0.05 | 12.0 | 0.3 | — | 87.65 | 212 | FAIL | 60 |
| 8 | 0.05 | 12.0 | — | — | 87.95 | 318 | FAIL | 25 |
| 9 | 0.05 | 12.0 | — | 0.07 | 87.88 | 254 | FAIL | 100 |
| 10 | 0.05 | 24.0 | 0.1 | — | 75.85 | 316 | FAIL | 100 |

TABLE 3

| | | | | | | | | Drip Test |
|---|---|---|---|---|---|---|---|---|
| | | | | | | Smoke | Smoke | (% of |
| | TDBPP | PC-Br | KSS | Rimar Salt | PC-CN | Density | Density | passing |
| Sample | (wt %) | (wt %) | (wt %) | (wt %) | (wt %) | (avg) | (Pass/Fail) | samples) |
| 11 | 0.05 | — | 0.1 | — | 99.85 | 100 | PASS | 20 |
| 12 | 0.05 | 3.0 | 0.1 | — | 96.85 | 111 | PASS | 60 |
| 13 | 0.05 | 6.0 | 0.1 | — | 93.85 | 106 | PASS | 60 |
| 14 | 0.05 | 6.0 | 0.3 | — | 93.65 | 97 | PASS | 100 |
| 15 | 0.05 | 8.0 | 0.1 | — | 91.85 | 132 | PASS | 0 |
| 16 | 0.05 | 12.0 | 0.1 | — | 87.85 | 158 | PASS | 60 |
| 17 | 0.05 | 12.0 | 0.3 | — | 87.65 | 142 | PASS | 100 |
| 18 | 0.05 | 12.0 | — | — | 87.95 | 315 | FAIL | 60 |
| 19 | 0.05 | 12.0 | — | 0.07 | 87.88 | 207 | FAIL | 80 |
| 20 | 0.05 | 24.0 | 0.1 | — | 75.85 | 267 | FAIL | 100 |

Comparative Samples 1-10 were examples containing polycarbonate resin found in current flame retardant sheets, with various amounts of the flame retardant additives and brominated polycarbonate described above. Samples 1-4 passed the smoke density test, but the sheets failed the drip test. The KSS did not overcome the low amounts of brominated polycarbonate content to pass the drip test. Samples 5-10 all failed the smoke density test, even though Samples 9 and 10 passed the drip test. Increases in the amounts of brominated polycarbonate caused the sheets to fail the smoke density test. The added KSS, when combined with the linear polycarbonate resin, was not effective to reduce the increase in smoke generation that resulted from the increase in bromine content. Moreover, use of a different flame retardant salt, such as Rimar salt in Sample 9, produced an even worse result in the smoke density test. So as can be seen from Comparative Samples 1-10, the combination of KSS in a standard linear polycarbonate resin was ineffective in satisfying both the drip test and the smoke density test, regardless of the bromine content included therein.

Samples 11-20 were sheet formulations containing the cyanophenyl endcapped polycarbonate resin, with various amounts of the KSS and the brominated polycarbonate resin. Samples 11-17 with the cyanophenyl endcapped polycarbonate resin passed the smoke density test. And in Samples 14 and 17 in particular, the sheets passed both the smoke density test and the drip test. A 0.3 wt % content of KSS was effective in passing the smoke density test, whether the sheet composition contained 6 wt % or 12 wt % brominated polycarbonate. Moreover, the combination of brominated polycarbonate, 0.3 wt % KSS, and the balance cyanophenyl endcapped polycarbonate was successful in passing the drip test. A lower weight percentage of KSS, nor the use of an alternative salt like Rimar salt, was able to produce a sheet that could satisfy both tests. As seen in Samples 19 and 20, even with the cyanophenyl endcapped polycarbonate and a substantial amount of brominated polycarbonate (up to 24 wt %) present in the composition, the samples failed at least the smoke density test. The cyanophenyl endcapped polycarbonate, therefore, is capable of producing a transparent flame retardant sheet suitable for aircraft interiors when it is combined with 6 wt % to 12 wt % or more of brominated polycarbonate, and greater than 0.1 wt % of KSS.

Advantageously, the flame retardant polycarbonate compositions herein comprise a cyanophenyl endcapped polycarbonate resin in combination with an optimal amount of aromatic sulphone sulphonate (e.g., KSS) and brominated polycarbonate. This composition is capable of producing a transparent sheet that is able to satisfy both the smoke and flammability requirements for use in aircraft interiors. By utilizing the cyanophenyl endcapped polycarbonate resin, rather than the polycarbonate resins currently found in transparent flame retardant sheets, the thermoplastic sheet as described herein is better able to satisfy the smoke density and flammability standards set for use in aircraft interiors. The unique combination of cyanophenyl endcapped polycarbonate resin, with KSS and brominated polycarbonate produces a flame retardant sheet capable of meeting stringent flame safety guidelines, while also being able to satisfy airline-specific smoke, toxicity, and optical requirements.

Ranges disclosed herein are inclusive and combinable (e.g., ranges of “up to 25 wt %, or, more specifically, 5 wt % to 20 wt %”, is inclusive of the endpoints and all intermediate values of the ranges of “5 wt % to 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thermoplastic resin composition, comprising:
a cyanophenyl endcapped polycarbonate resin;
an aromatic sulphone sulphonate; and
brominated polycarbonate;
wherein the composition, when in the form of a 3 mm thick extruded sheet, has a smoke density of less than 200 at an exposure period of 240 seconds in accordance with the smoke density test as set forth in ASTM E662-06, and has no burning drips on the sheet for a duration of 10 minutes in accordance with the flammability test as set forth in NF-P-92-505.

2. The composition of claim 1, wherein the aromatic sulphone sulphonate is present in an amount of 0.01 wt % to 0.6 wt %, based on the total weight of the composition.

3. The composition of claim 2, wherein the aromatic sulphone sulphonate is present in an amount of 0.1 wt % to 0.4 wt %, based on the total weight of the composition.

4. The composition of claim 3, wherein the potassium aromatic sulphone sulphonate is present in an amount of 0.25 wt % to 0.35 wt %, based on the total weight of the composition.

5. The composition of claim 1, wherein the aromatic sulphone sulphonate comprises an alkali metal sulphone sulphonate.

6. The composition of claim 5, wherein the aromatic sulphone sulphonate comprises potassium diphenylsulphone sulphonate.

7. The composition of claim 1, wherein the brominated polycarbonate comprises 24 wt % to 28 wt % bromine, based on the total weight of the brominated polycarbonate.

8. The composition of claim 7, wherein the brominated polycarbonate is present in an amount of 1 wt % to 20 wt %, based on the total weight of the composition.

9. The composition of claim 8, wherein the brominated polycarbonate is present in an amount of 2 wt % to 15 wt %, based on the total weight of the polycarbonate resin.

10. The composition of claim 1, wherein the cyanophenyl endcapped polycarbonate is a polycarbonate having repeating structural carbonate units of the formula 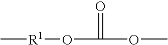
wherein at least 60 percent of the total number of R¹ groups contain aromatic organic groups and the balance thereof are aliphatic, alicyclic, or aromatic groups; and
wherein the polycarbonate comprises cyanophenyl carbonate endcapping groups derived from reaction with a cyanophenol of the formula 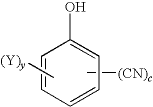
wherein Y is a halogen, C₁₋₃ alkyl group, C₁₋₃ alkoxy group, C₇₋₁₂ arylalkyl, alkylaryl, or nitro group, y is 0 to 4, and c is 1 to 5, provided that y+c is 1 to 5.

11. The composition of claim 10, wherein the cyanophenyl endcapping groups are present in an amount of 1 to 9 cyanophenyl carbonate units per 100 R¹ units.

12. The composition of claim 10, wherein the cyanophenol is p-cyanophenol, 3,4-dicyanophenol, or a combination comprising at least one of the foregoing phenols.

13. A thermoplastic composition, comprising:
0.01 wt % to 0.6 wt % aromatic sulphone sulphonate;
a brominated polycarbonate, in an amount such that the composition comprises 0.26 wt % to 5.2 wt % bromine; and
a cyanophenyl endcapped polycarbonate.

14. A sheet comprising:
a thermoplastic composition, comprising:
0.01 wt % to 0.6 wt % aromatic sulphone sulphonate;
a brominated polycarbonate, in an amount such that the composition comprises 0.26 wt % to 5.2 wt % bromine; and
a cyanophenyl endcapped polycarbonate.

15. The sheet of claim 14, wherein the sheet, at a thickness 3 mm, has a smoke density of less than 200 at an exposure period of 240 seconds in accordance with the smoke density test as set forth in ASTM E662-06, and has no burning drips on the sheet for a duration of 10 minutes in accordance with the flammability test as set forth in NF-P-92-505.

16. An aircraft interior component comprising the sheet of claim 15.

17. The component of claim 16, wherein the aircraft interior component comprises a partition wall, cabinet wall, sidewall panel, ceiling panel, floor panel, equipment panel, light panel, window molding, window slide, storage compartment, galley surface, equipment housing, seat housing, speaker housing, duct housing, storage housing, shelf, tray, or a combination comprising at least one of the foregoing.

18. The sheet of claim 14, wherein the sheet has a haze level of less than or equal to 6%, when measured at a thickness of 5 millimeters, in accordance with ASTM D1003-00, Procedure A, illuminant C.

19. A sheet comprising:
thermoplastic resin composition, comprising:
a cyanophenyl endcapped polycarbonate resin;
an aromatic sulphone sulphonate; and
brominated polycarbonate;
wherein the sheet, at a thickness 3 mm, has a smoke density of less than 200 at an exposure period of 240 seconds in accordance with the smoke density test as set forth in ASTM E662-06, and has no burning drips on the sheet for a duration of 10 minutes in accordance with the flammability test as set forth in NF-P-92-505; and
wherein the sheet has a haze level of less than or equal to 6%, when measured at a thickness of 5 millimeters, in accordance with ASTM D1003-00, Procedure A, illuminant C.
